(19) United States
(12) Patent Application Publication
(10) Pub. No.: US 2025/0292485 A1
(43) Pub. Date: Sep. 18, 2025

(54) MATERIAL AGNOSTIC DENOISING

(71) Applicant: NVIDIA Corporation, Santa Clara, CA (US)

(72) Inventors: Christoph Hermann Schied, Santa Clara, CA (US); Alexander Georg Keller, Berlin (DE)

(21) Appl. No.: 18/912,355

(22) Filed: Oct. 10, 2024

Related U.S. Application Data
(60) Provisional application No. 63/566,591, filed on Mar. 18, 2024.

(51) Int. Cl. G06T 15/06; G06T 3/40; G06T 5/70; G06T 7/90; G06V 10/30

(52) U.S. Cl. CPC G06T 15/06; G06T 3/40; G06T 5/70; G06T 7/90; G06V 10/30; G06T 2207/20081; G06T 2207/20084

(57) ABSTRACT

In photorealistic image synthesis by light transport simulation, the colors of each pixel are computed by evaluating an integral of a high-dimensional function. In practice, the pixel colors are estimated by using Monte Carlo and quasi-Monte Carlo methods to sample light transport paths that connect light sources and cameras and summing up the contributions to evaluate the integral. Because of the sampling, images appear noisy when the number of samples is insufficient. Due to the lack of information, denoising the shaded images introduces artifacts, for example, blurred the images. Denoising before material shading enables real-time light transport simulation, producing high visual quality even for low sampling rates (avoiding the blurred shading). The light transport integral operator is evaluated by a neural network, requiring data from only a single frame.

### CLAIM OF PRIORITY

This application claims the benefit of U.S. Provisional Application No. 63/566,591 titled “Material Agnostic Denoising,” filed Mar. 18, 2024, the entire contents of which is incorporated herein by reference.

### BACKGROUND

In photorealistic image synthesis by light transport simulation, the colors of each pixel are computed by evaluating an integral of a high-dimensional function. In practice, the pixel colors are estimated by using Monte Carlo and quasi-Monte Carlo methods to sample light transport paths that connect light sources and cameras and summing up contributions from the light sources to evaluate the integral. Because of the sampling, images appear noisy when the number of samples is insufficient. Due to the lack of information, denoising the shaded images introduces artifacts, for example, blurred the images. There is a need for addressing these issues and/or other issues associated with the prior art.

### SUMMARY

Embodiments of the present disclosure relate to material agnostic denoising. Light transport for photo-realistic images synthesis can be efficiently simulated by accumulating the contributions of sampled light transport paths that connect cameras and the light sources. In real-time rendering, the practical compute budget often limits the number of light transport paths that can be sampled, resulting in noisy images. Interestingly, a human observer easily understands a noisy image. A noisy image contains a sufficient amount of information to recover the image and therefore denoisers have been applied to noisy images to create noise-free images by filtering. While early denoisers are based on classic image processing, advanced algorithms take advantage of machine learning, especially convolutional neural networks.

In contrast with conventional solutions, image quality is improved by removing noise before material shading rather than filtering already shaded noisy images. Denoising before material shading is material agnostic, enables real-time light transport simulation, and produces high visual quality even for low sampling rates (avoiding the blurred shading). The light transport integral operator is evaluated by a neural network, requiring data from only a single frame. The neural network is efficient to train, is compatible with existing denoisers and temporal anti-aliasing techniques and may be integrated with physically based rendering algorithms.

A system, method, and computer readable medium are disclosed for synthesizing content. In an embodiment, incident radiance produced by evaluating light transport paths traced in a three-dimensional (3D) scene is received and projected onto a vector-valued function to compute projected irradiance in a higher dimensional space (e.g., an incident light field). The projected irradiance is denoised in the high dimensional space to produce denoised irradiance and a color is computed for each pixel of the synthesized content using the denoised irradiance and material parameters for the 3D scene.

A system, method, and computer readable medium are disclosed for parametric integration. In an embodiment, at least one function (Lᵢ(x, ω)) to be integrated for synthesizing content is projected onto at least one (parametric) linear vector space spanned by the components of a vector (E) of functions, producing at least one set of projections (μ). A parametric integral of the at least one function is approximated by a machine learned function (M) using the at least one set of projections of the at least one function, where the machine learned function is trained to approximate the parametric integral. The content is synthesized based on the parametric integral.

### BRIEF DESCRIPTION OF THE DRAWINGS

The present systems and methods for material agnostic denoising are described in detail below with reference to the attached drawing figures, wherein:

FIG. 1A illustrates an image synthesized without any denoising and with denoising before material shading, in accordance with an embodiment.

FIG. 1B illustrates a block diagram of an example content synthesis system suitable for use in implementing some embodiments of the present disclosure.

FIG. 1C illustrates a comparison of the components of the projected irradiance and the denoised projected irradiance, in accordance with an embodiment.

FIG. 1D illustrates a visualization of the denoiser inputs, in accordance with an embodiment.

FIG. 2A illustrates a block diagram of an example denoiser from FIG. 1B suitable for use in implementing some embodiments of the present disclosure.

FIG. 2B illustrates an example material shading unit from FIG. 1B suitable for use in implementing some embodiments of the present disclosure.

FIG. 2C illustrates a flowchart of a method for synthesizing content, in accordance with an embodiment.

FIG. 3A illustrates an example material shading unit training configuration suitable for use in implementing some embodiments of the present disclosure.

FIG. 3B illustrates an example denoiser training configuration suitable for use in implementing some embodiments of the present disclosure.

FIG. 3C illustrates a flowchart of another method for synthesizing content, in accordance with an embodiment.

FIG. 4 illustrates an example parallel processing unit suitable for use in implementing some embodiments of the present disclosure.

FIG. 5A is a conceptual diagram of a processing system implemented using the PPU of FIG. 4, suitable for use in implementing some embodiments of the present disclosure.

FIG. 5B illustrates an exemplary system in which the various architecture and/or functionality of the various previous embodiments may be implemented.

FIG. 5C illustrates components of an exemplary system that can be used to train and utilize machine learning, in at least one embodiment.

FIG. 6 illustrates an exemplary streaming system suitable for use in implementing some embodiments of the present disclosure.

### DETAILED DESCRIPTION

Systems and methods are disclosed related to material agnostic denoising. Light transport for photo-realistic images synthesis can be efficiently simulated by accumulating the contributions of sampled light transport paths that connect cameras and the light sources. In real-time rendering, the practical compute budget often limits the number of light transport paths that can be sampled, resulting in noisy images. Interestingly, a human observer easily understands a noisy image. Based on the observation that a noisy image still contains a sufficient amount of information to recover it from noise, filtering techniques have been devised. While early denoisers are based on classic image processing, advanced algorithms take advantage of convolutional neural networks.

In contrast with conventional solutions, image quality is improved by removing noise before material shading rather than filtering already shaded noisy images. Denoising before material shading is material agnostic, enables real-time light transport simulation, and produces high visual quality even for low sampling rates (avoiding the blurred shading). The light transport integral operator is evaluated by a neural network, requiring data from only a single frame. As the real-time rendering technique requires neither motion vectors nor other temporal information within a frame, it is straightforward to implement. Furthermore, the neural network is efficient to train, is compatible with existing denoisers and temporal anti-aliasing techniques and may be integrated with physically based rendering algorithms. In addition, the training procedure is independent of the actual material parameters of the content to be rendered.

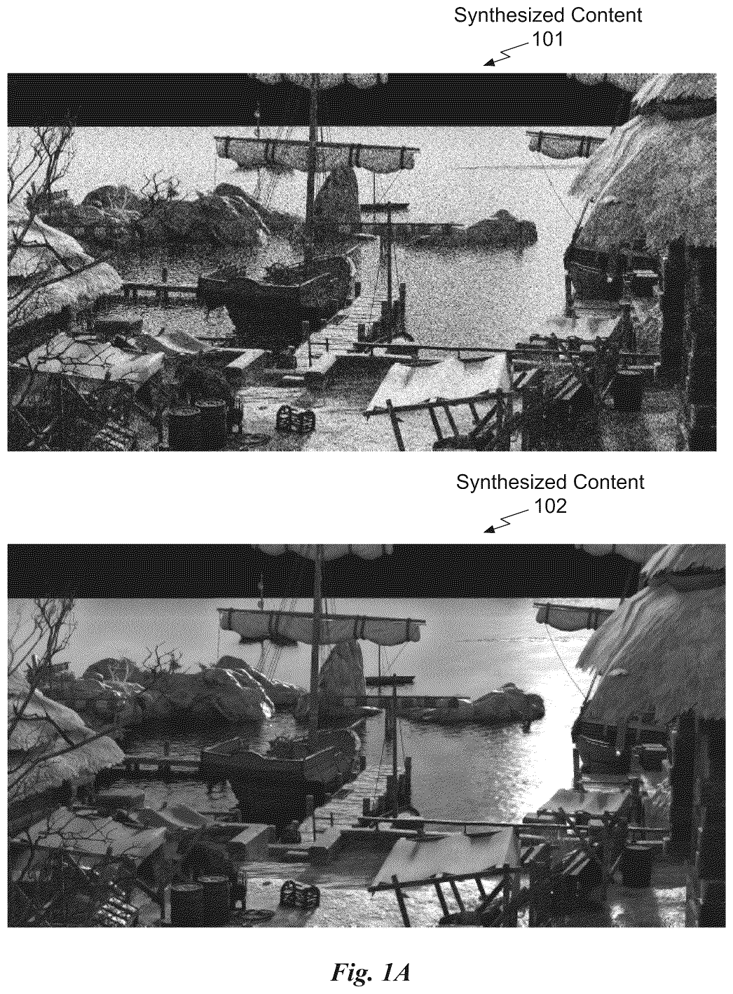

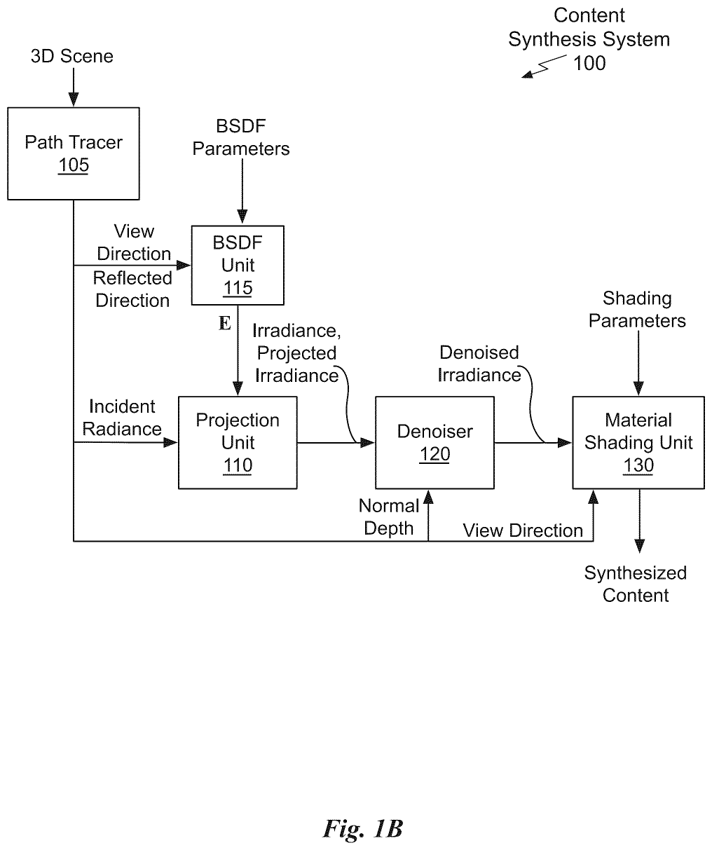

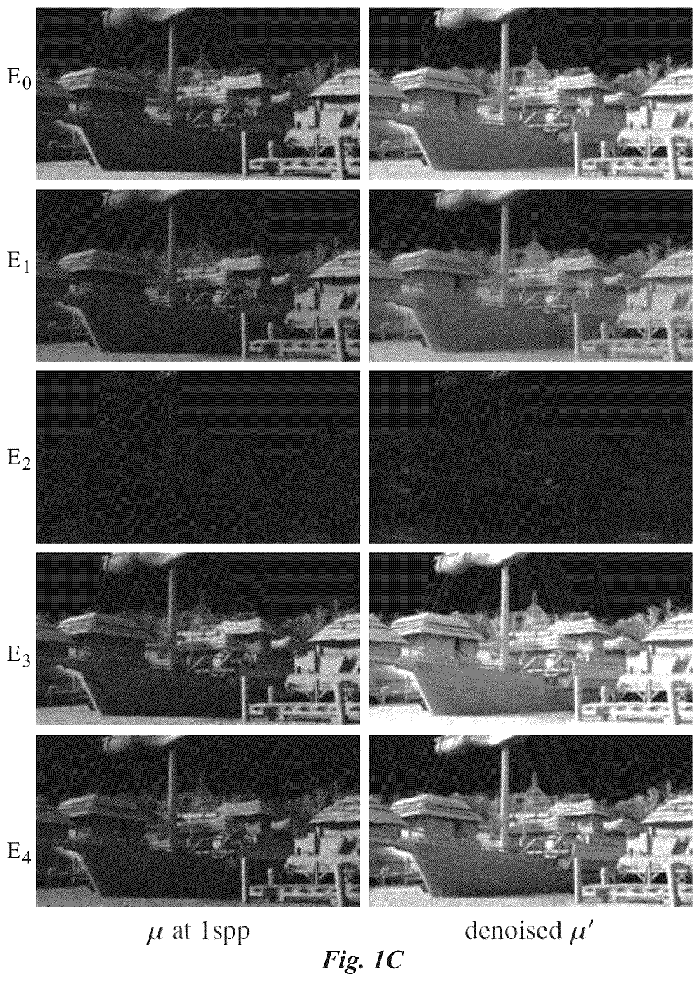

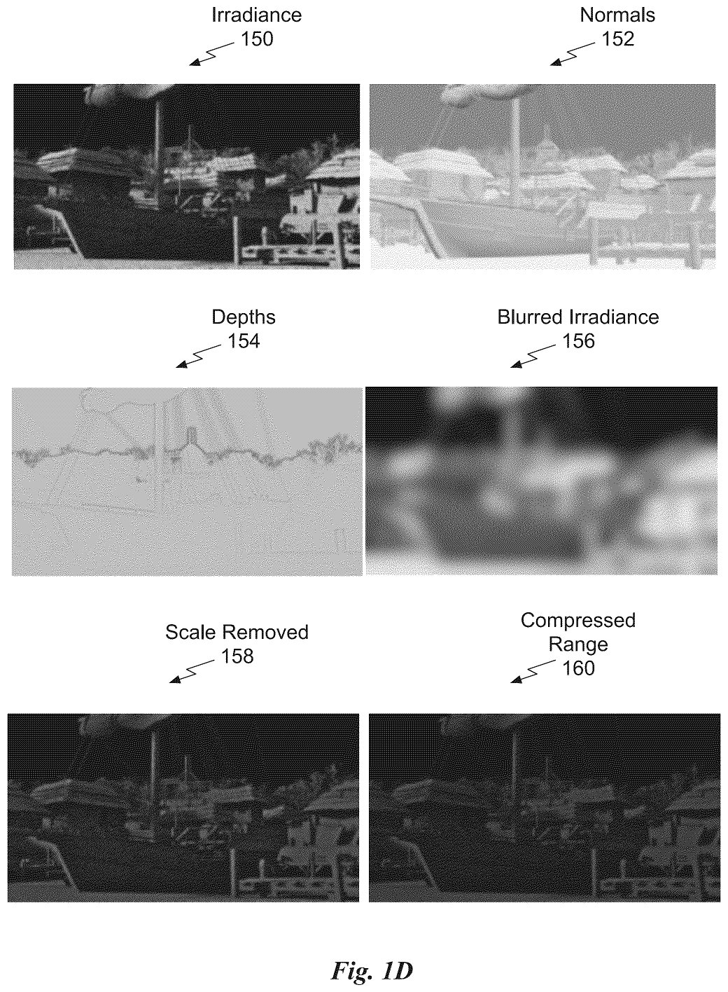

FIG. 1A illustrates an image synthesized without any denoising and with denoising before material shading, in accordance with an embodiment. The synthesized content 101 is synthesized by a classic shading pipeline using 1 spp without denoising and the synthesized content 102 is synthesized using 1 spp with denoising before material shading. Compared with the synthesized content 102 that includes areas of bright reflection on the water's surface and foreground shore, contrasting with dark areas of the boat and dock posts, the synthesized content 101 appears dull, more diffuse and has no reflective surfaces. The synthesized content 102 illustrates fine grained details and smooth uniform surfaces, such as the foreground canopy, whereas the synthesized content 101 appears coarse grained, particularly the water and uniform surfaces.

For shading, reflected radiance Lᵣ may be computed as

$${L}_{r} ( x , {ω}_{r} ) = {\int }_{{S}_{+}^{2} ( x )} f ( x , ω , {ω}_{r} ) {L}_{i} ( x , ω ) cos θ d ω \qquad Eq . ( 1 )$$

integrating over a hemisphere S in a low dimensional space. The integral in equation (1) may be decomposed into two functions, a first that is spatially varying (dependent on x) and a second basis function that is not spatially varying. The first function is ƒ(x, ω, ωᵣ) and the vector-valued function, a view-dependent light field encoder, is E(ω, ωᵣ). In contrast with conventional techniques that learn E_{θ}, one vector E is selected based on the bi-directional scattering distribution function (BSDF).

$${L}_{r} ( x , {ω}_{r} ) \approx {M}_{θ} ( x , {ω}_{r} , {\int }_{{S}_{+}^{2} ( x )} E ( ω , {ω}_{r} ) {L}_{i} ( x , ω ) cos θ d ω ) = {M}_{θ} ( x , {ω}_{r} , {μ}^{*} ) \qquad Eq . ( 2 )$$

A machine learned function M_{θ} in equation (2) approximates the integral operator in equation (1). The operator acts on the projected irradiance μ*, which is the integral that projects the incident radiance Lᵢ(x, ω) onto the vector-valued function E(ω, ωᵣ) in a higher dimensional space (higher compared with the dimension of equation (1)). The machine learned material function M_{θ} is learned to approximate the integral in equation (1). The view-dependent light field encoder E maps into linear latent space and the machine learned material function M_{θ} maps from linear latent space to RGB space, applies materials to the linear latent space representation, and approximates the integral operator. Given training data, M_{θ} may be learned.

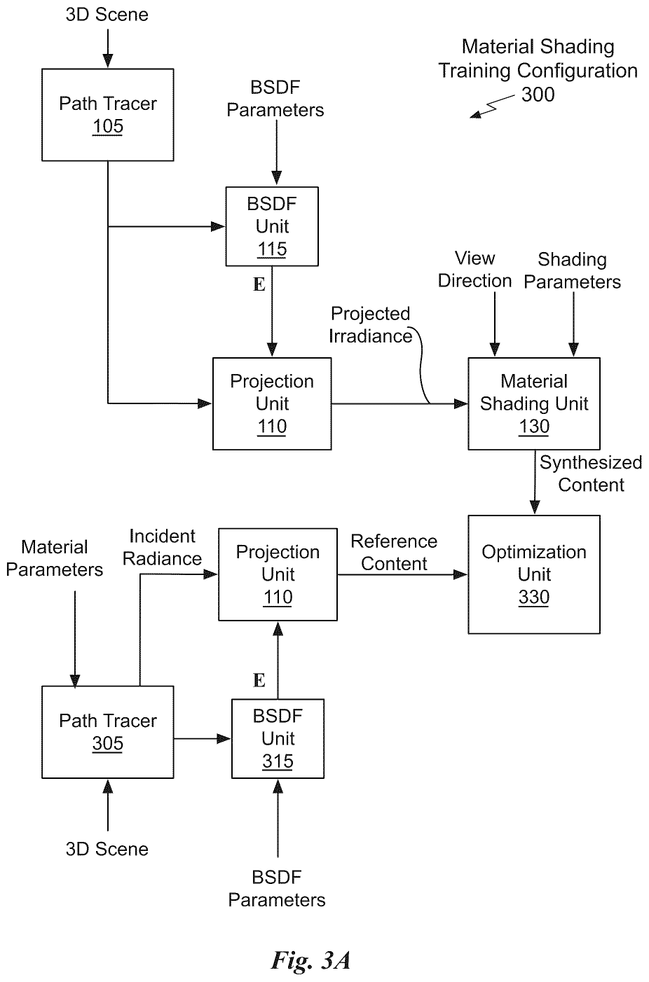

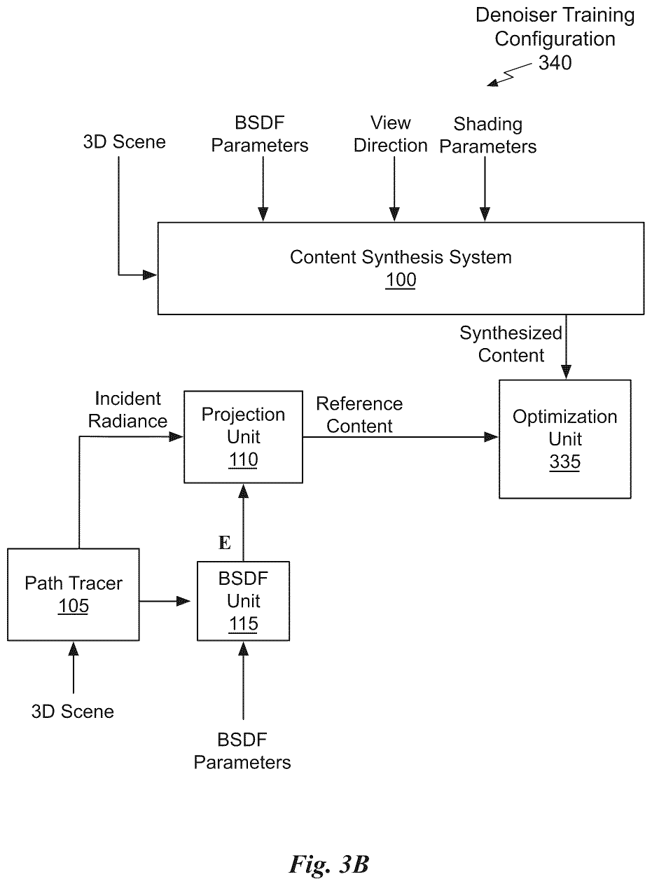

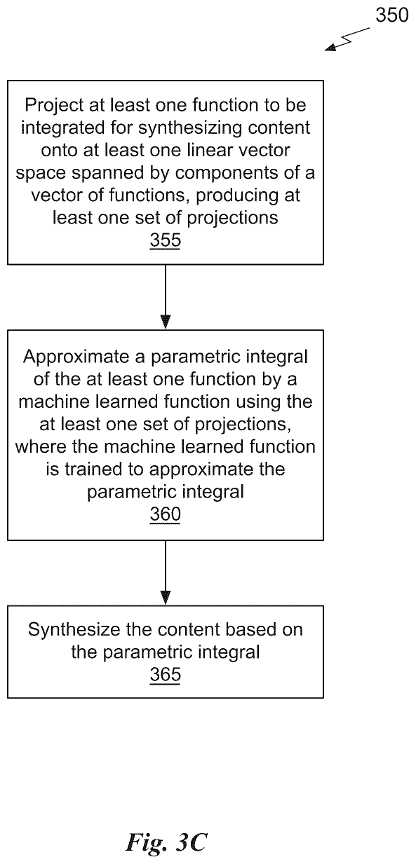

The real-time inference algorithm for the parametric integral in equation (1) is described in conjunction with FIGS. 1B, 1C, 1D, 2A, 2B, 2C, and 3C. The efficient training of M_{θ} and appropriate loss functions are described in conjunction with FIGS. 3A and 3B. For the sake of compactness, a familiarity with path tracing and sampling path space is assumed, as taught by Pharr, M. et al. in “Physically Based Rendering—From Theory to Implementation.” Morgan Kaufmann, fourth edition (2023). Without loss of generality, for the integral kernel ƒ, the isotropic Disney principled bi-directional scattering distribution function (BSDF) without clear coat as implemented by the DefaultLitMaterial in the Unreal Engine 4. In the context of the following description, for the sake of clarity, whenever only a single color component in {R, G, B} is mentioned, the respective object is also considered for the other color components.

Following path tracing to compute the incident radiance for each sample, a neural shading pipeline, such as is used to synthesize the synthesized content 102 in FIG. 1A, performs three steps. Path tracing also computes, for each sample, an incoming/incident light direction (ωᵢ), surface normal vector, depth vector, and outgoing/reflected light direction (ωᵣ). The first step is to project the incident radiance Lᵢ(x, ω) into a high dimensional space (d dimensions) according to a vector of functions, E(ω, ωᵣ)∈ [symbol] , spanning that space. The projection onto E(ω, ωᵣ) hence encodes the incident light field. The second step denoises (filters) the projected incident radiance in the high dimensional space to produce a denoised incident radiance. The denoising process may use the surface normal and depth gradient at each sample to guide the denoising process. The third step uses the denoised incident radiance and shading parameters to perform the material shading and compute a color for each pixel (x) of the synthesized image. The third step may be performed by the machine learned function M_{θ} (material decoder) performs the material shading by approximating the integral operator in equation (1).

FIG. 1B illustrates a block diagram of an example content synthesis system 100 suitable for use in implementing some embodiments of the present disclosure. The content synthesis system 100 includes a path tracer 105, BSDF unit 115, projection unit 110, denoiser 120, and material shading unit 130. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the content synthesis system 100 is within the scope and spirit of embodiments of the present disclosure.

In an embodiment, the denoiser 120 and/or the material shading unit 130 is implemented using a neural network model. The path tracer 105 traces rays into a 3D scene and outputs a view direction, reflected direction, incident radiance, normal vector, and depth for each ray that intersects an object. The components of the vector-valued function E(ω, ωᵣ) span a directionally dependent space to represent irradiance. The dependence on pairs of directions in the view-aligned tangent space differentiates E(ω, ωᵣ) from classic vectors of basis functions. Note that E is independent of spatial location, as neighborhood is implicit across image space. The BSDF unit 115 evaluates each function vector of E, where each component of the vector of functions is a linearly independent function derived from a BSDF model.

A first component of the projected irradiance is computed as E₀(ω, ωᵣ)=1 and equals classic irradiance (diffusely reflected radiance) which is independent of ωᵣ. The first component allows for representation of averages. In fact, the first component integrates irradiance, which is essential for normalizing purposes later on. The first components for each color channel are accumulated for each of n samples to compute the irradiance, (μ_{R,0}, μ_{G,0}, μ_{B,0}).

The remaining components of the projected irradiance are computed using the view direction and the reflected direction according to E₁, . . . , E_{d-1}, where d is the dimension of E (number of functions in the vector). The projected irradiance μ is computed by accumulating the remaining components for each of the n samples for each color channel, μ=(μ_{R}, μ_{G}, β_{B}), where the projected irradiance for the red channel μ_{R}=(μ_{R,0}, . . . , μ_{R,d-1}). The projected irradiance estimate u may have a high dynamic range which is difficult to denoise using a neural network. Therefore, some pre-processing is needed prior to the denoising operation.

In an embodiment, four more linearly independent functions are created from the BSDF model, amounting to d=5: For a white base color (=1), the BSDF parameters are specified as shown in TABLE 1.

TABLE 1
BSDF parameters

| | metallic | specular | roughness |
|---|---|---|---|
| E₁ | 0.5 | 0.5 | 0.1 |
| E₂ | 1.0 | 0.0 | 0.1 |
| E₃ | 0.0 | 1.0 | 0.1 |
| E₄ | 1.0 | 1.0 | 0.6 |

E thus consists of the constant function one and four linearly independent directionally dependent lobes extracted from the underlying BSDF model. Such a construction principle for E(ω, ωᵣ) can be applied to any other BSDF model as well.

The BSDF unit 115 evaluates the projected irradiance integral in equation (2) using Monte Carlo or quasi-Monte Carlo integration. Summing the contributions (Rᵢ, Gᵢ, Bᵢ) of the i-th path space sample according to equation (1), a concatenated vector is accumulated for each color channel without weighing by the BSDF ƒ, also known as “BSDF stealing.” As E₀ (ω, ωᵣ)=1, the components

$$Eq . ( 3 )$$

$$μ := [ \frac{1}{n} {\sum }_{i = 0}^{n - 1} E ( {ω}_{i} , {ω}_{r} ) {R}_{i} \vert \frac{1}{n} {\sum }_{i = 0}^{n - 1} E ( {ω}_{i} , {ω}_{r} ) {G}_{i} \vert \frac{1}{n} {\sum }_{i = 0}^{n - 1} E ( {ω}_{i} , {ω}_{r} ) {B}_{i} ] ∈ {ℝ}^{3 d}$$

accumulate the irradiance.

In the context of the following description, in the notation that is used, the path space sample contributions (Rⱼ, Gⱼ, Bⱼ) are already divided by their respective probability. Furthermore, all weights of sampling techniques like multiple importance sampling for sampling over the hemisphere and next event estimation are included.

FIG. 1C illustrates a comparison of the components of the projected irradiance and the denoised projected irradiance, in accordance with an embodiment. The implementation uses n=1 sample per pixel. One path that scatters at the primary hitpoint is sampled as seen from the viewpoint and in the same location sample the light sources for next event estimation. Both contributions are summed up using their respective multiple importance sampling weights while omitting the BSDF factor as mentioned before.

The components of the projected irradiance include μ at 1 sample per pixel (1 spp) and the denoised projected irradiance μ′. Note that the first component (top row) corresponding to E₀ actually is the classic irradiance (diffuse reflected light). The other basis functions (components) in the vector-valued function, E₁, E₂, E₃, and E₄ are shown in each successive row. The geometry is recognizable in the images as the cos θᵣ term and next event estimation is included in the estimates. Next event estimation contributes shadows from visibility and quadratic attenuation with distance. The denoiser 120 is trained to take advantage of the geometry clues while filtering. Note that the color variations (not visible) of the projected irradiance μ′ as compared to the denoised projected irradiance μ′ are a consequence of how color channel scale is learned by the denoiser 120 and compensated in the material shading unit 130.

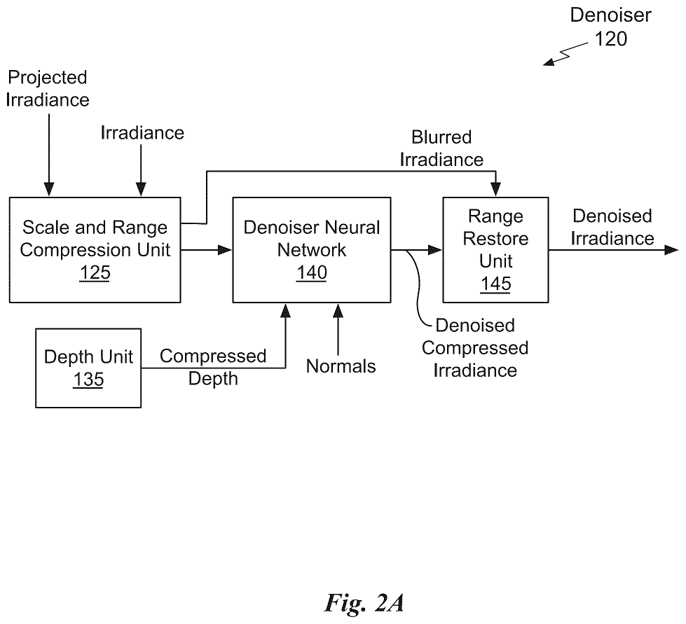

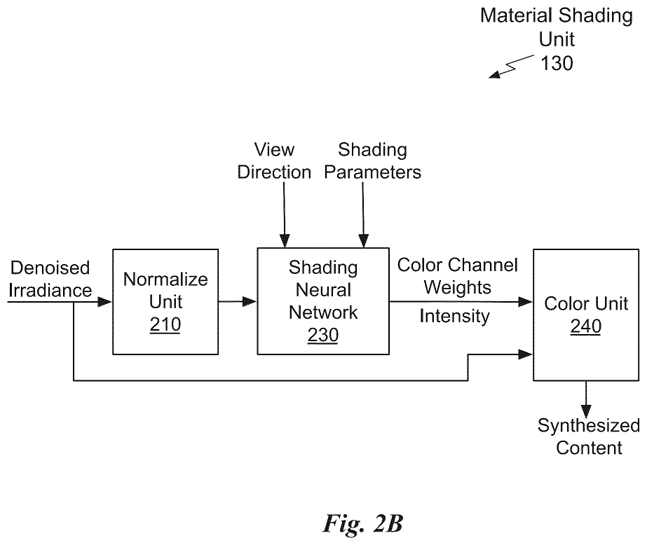

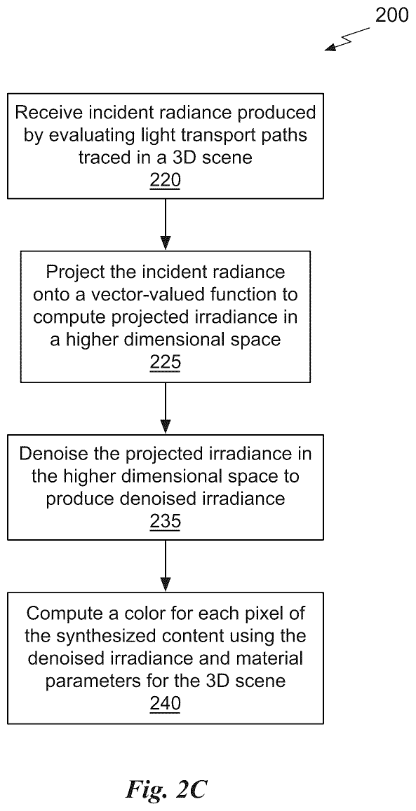

Referring back to FIG. 1B, the denoiser 120 receives the irradiance, projected irradiance, normal vectors, and depth vectors and performs some operations to prepare for denoising the projected irradiance. A blurred irradiance \hat{μ}=(\hat{μ}_{R,0}, \hat{μ}_{G,0}, \hat{μ}_{B,0}) is computed. The blurred irradiance is practically noise free. Dividing the irradiance by the blurred irradiance normalizes scale (compressing the dynamic range), removing the brightness. However, to avoid division by zero a max of either the blurred irradiance or a small ϵ is used as the divisor. A logarithm is then applied to compress the remaining high dynamic range noise, producing range compressed irradiance. The denoiser 120 is described in detail in conjunction with FIG. 2A.

The denoised irradiance is then processed by the material shading unit 130 to generate the synthesized content. In an embodiment, the material shading unit 130 comprises a material decoder M_{θ} that acts as the integral operator on the denoised irradiance and approximates the reflected radiance Lᵣ(x, ωᵣ) according to the shading parameters at x and viewing direction ωᵣ. The material shading unit 130 is described in detail in conjunction with FIG. 2B.

In order to overcome blur due to filtering shaded images, the denoiser 120 filters noise in projected irradiance space before shading. Then, shading after filtering adds texture detail. Such a principled approach results in crisper images, because detail is not masked by noise. In principle, the variance of the parametric projected irradiance μ in equation (3) is reduced by applying a U-Net U_{θ} with the objective to make it a better estimate of the projected irradiance integral equation (2).

Previous denoising work in graphics teaches that neural networks do not cope well with high dynamic range input like the projected irradiance estimate μ. This issue is addressed by two subsequent, invertible transformations: First, the scale is removed from the irradiance by dividing it by a local average of the irradiance. While then free of scale, the remaining noise still may have a high dynamic range and hence is compressed using a logarithm.

Ideally, μ would be normalized using the true irradiance from μ*, which would perfectly remove scale, but obviously is not available. However, scaling μ with the reciprocal local estimate of the average irradiance is feasible. Since the same estimate must be used to restore brightness after the non-linear denoising operation, it needs to be practically noise free. Applying a wide Gaussian filter approximated by à-trous wavelets to the sampled irradiance yields the desired local averages to remove the scale. To compute the noise free blurred irradiance (\hat{μ}_{R,0}, \hat{μ}_{G,0}, \hat{μ}_{B,0}), the irradiances (μ_{R,0}, μ_{G,0}, μ_{B,0}) are blurred by iterating an à-trous filter with a 5×5 Gaussian filter kernel 6 times to rapidly achieve a sufficiently large blur radius. In order to prevent fine geometry from being masked by noise, edge stopping heuristics are not applied. Note that opposite to division by the average, subtracting the average does not remove the scale.

The implementation starts by normalizing the projected irradiance vectors by their respective accumulated irradiances. Concatenated across the color channels, it produces
normalize (μ)

$$: = [ \frac{( {μ}_{R , 0} , … , {μ}_{R , d - 1} )}{max \{ {μ}_{R , 0} , ϵ \}} \vert \frac{( {μ}_{G , 0} , … , {μ}_{G , d - 1} )}{max \{ {μ}_{G , 0} , ϵ \}} \vert \frac{( {μ}_{B , 0} , … , {μ}_{B , d - 1} )}{max \{ {μ}_{B , 0} , ϵ \}} ] , \qquad Eq . ( 5 )$$

Where a small ϵ avoids numerical issues in very dark regions, especially divisions by zero. Note that whenever a component of (μ_{R,0}, μ_{G,0}, μ_{B,0}) is larger or equal to ϵ, its normalization is one, and smaller otherwise. This way zero components, which are quite common among colors, remain zero. The normalization removes the brightness and hence color from the components, leaving vectors of ratios of the components. This is necessary, as the color and hence brightness is restored later on using the blurred irradiance \hat{μ}. Exemplary for the red channel, input to the denoiser is then

$${μ}_{R}^{c} = compress ( {μ}_{R} ) = \frac{( {μ}_{R , 0 , … ,} {μ}_{R , d - 1} )}{max \{ {μ}_{R , 0} , ϵ \}} \cdot log ( 1 + \frac{{μ}_{R , 0}}{max \{ {\hat{μ}}_{R , 0} , ϵ \}} ) . \qquad Eq . ( 6 )$$

FIG. 1D illustrates a visualization of the denoiser 120 inputs, in accordance with an embodiment. Specifically, the input transformation consisting of scale removal and compression is illustrated. The denoiser 120 inputs include irradiance (μ_{R,0}, μ_{G,0}, μ_{B,0}) 150, normals 152, depths 154, and the blurred irradiance \hat{μ}=(\hat{μ}_{R,0}, \hat{μ}_{G,0}, \hat{μ}_{B,0}) 156 that is practically noise free. Dividing the irradiance by the blurred irradiance normalizes scale, yielding almost gray images shown in scale removed 158. The remaining high dynamic range noise is compressed by applying a logarithm to produce compressed range 160. Note that the logarithmic factor is zero, whenever the irradiance is zero and that black components remain black after the transformation.

FIG. 2A illustrates a block diagram of an example denoiser 120 from FIG. 1B suitable for use in implementing some embodiments of the present disclosure. The denoiser 120 includes a scale and range compression unit 125 that computes the blurred irradiance \hat{μ} and the range compressed irradiance. The scale and range compression unit 125 also normalizes the projected irradiance μ using the irradiance (dividing by max {μ₀, ϵ}). The normalized projected irradiance is scaled by the range compressed irradiance to produce compressed projected irradiance μ^{c} that is output to a denoiser neural network 140. In an embodiment, the denoiser neural network 140 comprises the U-Net U_{θ}.

To help the denoiser neural network 140 gather information across pixels, geometric cues are provided as inputs. The normal \hat{n} in x is transformed into view space in which it becomes independent of camera pose, allowing the denoiser neural network 140 to consider changing normals, for example, as present around edges. Information beyond the that provided by normals, may be revealed in the depth buffer. The range of depth values is highly scene dependent, and a high dynamic range may not work nicely with a trained denoiser neural network 140. Hence instead of mapping the values by scene-dependent scales or using minimum and maximum blurs of the depth buffer, a depth unit 135 generates compressed depth values from the depth buffer. The procedure follows the principles of the range compression applied to the irradiance to provide the compressed depth input to the denoiser neural network 140. Specifically, the distance from the viewpoint to x is blurred by iterating the aforementioned à-trous filter for three times. Each distance is then divided by its corresponding blurred depth, centered at zero by subtracting one, and clamped to the range of [−1,1] yielding the range compressed depth buffer \hat{d}. Hence, for a constant, non-zero depth, where the depth equals the blurred depth, the range compressed depth buffer is zero. Otherwise, the sign indicates the direction of gradients in depth to the denoiser neural network 140.

The denoiser neural network 140 as a convolutional neural network locally fixes brightness and hierarchically computes weighted averages across neighbors. The denoiser neural network 140 receives the compressed projected irradiance, compressed depth, and normals and generates denoised compressed irradiance in the high dimensional space. The normal vectors and compressed depth are used to enable consideration of geometric corners, edges, and discontinuities by the denoiser neural network 140. The denoiser neural network 140 output

$${μ}^{′} = ( {\hat{μ}}_{R , 0} , {\hat{μ}}_{G , 0} , {\hat{μ}}_{B , 0} ) ⊙ {U}_{θ} ( compress ( μ ) , \hat{n} , \hat{d} ) \qquad Eq . ( 7 )$$

is scaled by the blurred irradiance \hat{μ} to restore the dynamic range and color. A range restore unit 145 restores the brightness of the denoised compressed irradiance by scaling it by the blurred irradiance to produce the denoised irradiance μ′ in projected irradiance space. In equation (7) denotes the multiplication of each color component (see equation (5)) by its respective blurred irradiance. Note that the blurred irradiance is practically noise free, while a multiplication with the sampled irradiances (equation (3)) would add back the noise. The denoiser neural network 140 is trained to invert the logarithmic term in equation (6). Reconstruction of the image brightness is possible, because the à-trous transform preserves the average image brightness (the integral).

To understand the denoiser neural network 140, assume that μ*=μ=μ′, meaning that the projected irradiance is already denoised and hence

$${μ}_{R} = {\hat{μ}}_{R , 0} \cdot {U}_{θ} ( \frac{{μ}_{R}}{max \{ {μ}_{R , 0} , ϵ \}} \cdot log ( 1 + \frac{{μ}_{R , 0}}{max \{ {\hat{μ}}_{R , 0} , ϵ \}} ) , \hat{n} , \hat{d} ) .$$

Looking at the first component μ_{R,0} for ϵ→0 in the limit, the result is

$${μ}_{R , 0} = {\hat{μ}}_{R , 0} \cdot {U}_{θ} ( log ( 1 + \frac{{μ}_{R , 0}}{{\hat{μ}}_{R , 0}} ) , \hat{n} , \hat{d} ) ,$$

meaning that for μ_{R,0}>0 the denoiser neural network 140 learns to invert the logarithm and the addition, while the multiplication by the average \hat{μ}_{R,0} is explicitly modeled. For the case \hat{μ}_{R,0}>0 of a non-zero average and μ_{R,0}=0, the logarithm returns zero resulting in a zero output for a scale-invariant denoiser neural network 140. Finally, if \hat{μ}_{R,0}=0, PRO must be zero, too, because otherwise, the average cannot be zero. In that case, the factor \hat{μ}_{R,0}=0 is programmatically defined to zero out the result of the denoiser neural network 140. Note that using a function like tan h or a tone mapping operation such as

$$\frac{x}{1 + x}$$

instead of the logarithm results in worse performance, because these functions reach their asymptotes so quickly that their inversion becomes a numerical issue.

Now that the incident radiance is practically noise free in projected irradiance space, the denoised irradiance is processed by the material shading unit 130 to generate the synthesized content. In an embodiment, the material shading unit 130 comprises a material decoder M_{θ} that acts as the integral operator on the denoised irradiance and approximates the reflected radiance Lᵣ(x, ωᵣ) according to the shading parameters at x and viewing direction ωᵣ.

FIG. 2B illustrates an example material shading unit 130 from FIG. 1B suitable for use in implementing some embodiments of the present disclosure. The material shading unit 130 includes a normalize unit 210, a shading neural network 230, and a color unit 240. In an embodiment, the shading neural network 230 comprises the material neural network m_{θ}. First the denoised irradiance μ′ is normalized (divided by max{μ′₀, ϵ}) by the normalize unit 210 to produce μ″ for processing, by the shading neural network 230, along with shading parameters P(x, ωᵣ) and the view direction. The denoised irradiance μ′ is normalized for the same reasons as before in equation (5),

$${μ}^{″} = normalize ( {μ}^{′} ) := [ \frac{( {{μ}_{}^{′}}_{R , 1} , … , {μ}_{R , d - 1} )}{max \{ {μ}_{R , 0}^{′} , ϵ \}} \vert \frac{( {{μ}_{}^{′}}_{G , 1} , … , {μ}_{G , d - 1} )}{max \{ {{μ}^{′}}_{G , 0} , ϵ \}} \vert \frac{( {{μ}_{}^{′}}_{B , 1} , … , {μ}_{B , d - 1} )}{max \{ {{μ}^{′}}_{B , 0} , ϵ \}} ] \qquad Eq . ( 8 )$$

in order to decouple them from brightness, because it increases the efficiency of neural network processing.

The shading neural network 230 generates a set of weights for each color channel and an intensity I that is shared by the color channels. Given the shading parameters P(x, ωᵣ), the shading neural network 230

$${m}_{θ} ( P ( x , {ω}_{r} ) , {μ}^{″} ) \to ( {\hat{ω}}_{R} , {\hat{ω}}_{G} , {\hat{ω}}_{B} , I ) ∈ {ℝ}^{3 \times 3 + 1} , \qquad Eq . ( 9 )$$

computes three sets of three weights and the intensity I. The parameters P(x, ω) include the material parameters and the cos θᵣ specified by the angle θᵣ between the viewing direction ωᵣ and the surface normal \hat{n}, all evaluated in x. While the material base color ρ is normalized by its L²-norm, the other material parameters such as roughness, specularity, and metallicity are mapped to the range [−1,1] from their respective ranges. Then the shading neural network 230 normalizes each set of three weights by a softmax function

$$( {ω}_{R} , {ω}_{G} , {ω}_{B} ) = ( softmax ( {\hat{ω}}_{R} ) , softmax ( {\hat{ω}}_{G} ) , softmax ( {\hat{ω}}_{B} ) ) \qquad Eq . ( 10 )$$

such that weights per color channel sum up to one. Exemplary for the red (R) component, the shading neural network 230 (material decoder)

$$\begin{matrix}{M}_{θ , R} ( x , {ω}_{r} , {μ}_{R}^{′} ) : & = {μ}_{R , 0}^{′} \cdot I \cdot ( {\overbrace{0 \cdot {w}_{R , 0}}}^{black} + {\overbrace{{w}_{R , 1} \cdot {ρ}_{R}}}^{base color} + {\overbrace{1 \cdot {w}_{R , 2}}}^{white} ) \\ & = {μ}_{R , 0}^{′} \cdot I \cdot ( {\underbrace{{w}_{R , 1} \cdot {ρ}_{R} + {w}_{R , 2}}}_{∈ [ 0 , 1 ]} ) .\end{matrix} \qquad Eq . ( 11 )$$

is modeled as a convex combination of black (=0), the material base color ρ≡ρ(x)∈[0,1]³ (albedo, this time not normalized) evaluated at the shading point x, and white (=1) that is scaled by an intensity I and the filtered irradiance μ′_{R,0} from equation (7). The convex combination allows for representing any color in the RGB unit cube, where black and white can be mixed into the base color of the material. The intensity I is shared across color channels, while the filtered irradiance restores the range per color channel. This explains why the components=(μ′_{R,0}, μ′_{G,0}, μ′_{B,0}) were excluded from normalization in equation (8). Modeling the products explicitly avoids teaching multiplication to neural networks. The color unit 240 evaluates equation (11) to compute the colors for each pixel x in the synthesized content.

In an embodiment, the content synthesis system 100 uses machine learning only for the components that cannot be formulated in an analytic way. For example, teaching multiplication to neural networks is avoided and the number of inputs by is reduced by exploiting symmetries. To avoid numerical issues caused by the division by small numbers x, a too small divisor can be avoided by max {x, ϵ} or by adding the small number ϵ>0, i.e. dividing by x+ϵ. The former yields the actually desired result for x>ϵ, the latter smoothly compresses the signal towards zero and hence always is a tiny bit off the desired fraction. While the observable differences in normalization in equations (6) and (8) are subtle at least, restoring the scale in equations (7) and (11) is best with the original divisor without ϵ.

In an embodiment, m_{θ} is a ResNet that takes the one-dimensional viewing direction (according to the representation in tangent space, as defined before), a six dimensional material specification (Disney material parameters: roughness, specular, metal, and RGB albedo/basecolor/diffuse, all material parameters (roughness, metallic) are mapped from [0,1] to [−1,1] (enc-material) for improved processing in the shading neural network 230) as evaluated in x, and μ″, which is 3×5 dimensions. This amounts to 22 dimensions. In an embodiment, the neural network architecture of m_{θ} is a ResNet comprising six ResNet blocks with 16 neurons/lines each. Each fully connected layer has a bias term.

In an embodiment, the shading neural network 230 uses bias terms in all layers. These include the fully connected dimension adapters at the beginning and end of the shading neural network 230, as well as all layers in the ResNet blocks. All activation functions are the exponential linear unit (ELU)

$$E L U ( x ) = \{ \begin{matrix}x & x \geq 0 \\ α ( {e}^{x} - 1 ) & x < 0\end{matrix}$$

with α=1. For the shading neural network 230, ELU is superior to ReLU, which yields segmentation artifacts by capturing geometric discontinuities. Other than ReLU, ELU is continuously differentiable. In an embodiment, the shading neural network 230 does not use any norms and has about 3754 weights. In an embodiment, a U-Net used to implement the denoiser neural network 140 uses the ReLU activation function, it does neither use norms nor bias terms. In an embodiment, the U-Net uses one convolution per layer and ResNets for the stacked 1×1 convolutions, resulting in an efficient architecture. The denoiser neural network 140 has about 9 million weights.

Instead of working in screen space, the projected irradiance μ may be accumulated as a vector field in space using a hash grid data structure. A projected irradiance cache may be based on the principles of the neural radiance cache. Such a projected irradiance cache accumulates projected irradiance over time and hence may work well without a denoiser neural network 140. Therefore, the projected irradiance cache is amenable to dynamic content at the price of a certain lag when lighting is changing rapidly. Because such a representation of the projected irradiance in equation (2) can be queried anywhere in space, it can be super- and subsampled, which allows for efficient anti-aliasing and upscaling. In a sense, this is an efficient approach to unified denoising, super-resolution, and anti-aliasing.

FIG. 2C illustrates a flowchart of a method 200 for synthesizing content, in accordance with an embodiment. Each block of method 200, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 200 is described, by way of example, with respect to the content synthesis system 100 of FIG. 1B, the material shading training configuration 300 of FIG. 3A, and the denoiser training configuration 340 of FIG. 3B. However, this method may additionally or alternatively be executed by any one system, or any combination of systems, including, but not limited to, those described herein. Furthermore, persons of ordinary skill in the art will understand that any system that performs method 200 is within the scope and spirit of embodiments of the present disclosure.

At step 220, incident radiance produced by evaluating light transport paths traced in a three-dimensional (3D) scene is received. At step 225, the incident radiance is projected onto a vector-valued function to compute projected irradiance in a higher dimensional space (an incident light field). At step 235, the projected irradiance is denoised in the high dimensional space to produce denoised irradiance. At step 240, a color is computed for each pixel of the synthesized content using the denoised irradiance and material parameters for the 3D scene.

The denoiser neural network 140 and shading neural network 230 are trained in two separate passes: First, the shading neural network 230 is trained without the denoiser neural network 140 in a loop. The shading neural network 230 is trained using noise free images that may be rendered at high resolution to provide reference (ground truth) content. Then, the denoiser neural network 140 is trained using the already trained shading neural network 230. When training neural networks in computer graphics, a significant advantage of light transport simulation is that infinite sequences of unique, unbiased training pairs can be created on the fly just by sampling. Additionally, training the denoiser neural network 140 and shading neural network 230 separately is typically faster than simultaneously training both the denoiser neural network 140 and shading neural network 230.

FIG. 3A illustrates an example material shading unit training configuration 300 suitable for use in implementing some embodiments of the present disclosure. The material shading unit training configuration 300 comprises the path tracer 105, BSDF unit 115, projection unit 110, and material shading unit 130 from the content synthesis system 100. The material shading unit training configuration 300 also comprises a path tracer 305, BSDF unit 315, and an optimization unit 330. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the material shading unit training configuration 300 is within the scope and spirit of embodiments of the present disclosure.

In an embodiment, the shading neural network 230 (material decoder Me) within the material shading unit 130 is trained using procedurally generated examples without any ray tracing. The approximation equation (2) only depends on (x, ωᵣ) and hence is independent of statistics across pixels, which simplifies training. Therefore, instead of evaluating the BSDF parameters in a specific location x, material parameters are uniformly randomly sampled from their respective ranges for each training example. A path tracer 305 receives the randomly sampled material parameters and computes incident radiance for the 3D scene. In an embodiment, four uniformly distributed directions of incident radiance are sampled, alongside a uniformly randomly sampled outgoing direction ωᵣ. A BSDF unit 315 performs the same operations as the BSDF unit 115 to generate E. The projection unit 110 generates the reference content using the incident radiance and E. In an embodiment, the reference content is computed by evaluating the material implementation of a conventional 3D computer graphics game engine. Each light sample has a random RGB radiance uniformly sampled within [0, 16]. Note that the range is a free parameter since the intensity is decoupled from the neural network inputs.

Synthesized content for the 3D scene is generated using the path tracer 105, BSDF unit 115, projection unit 110, and the material shading unit 130. The optimization unit 330 receives the synthesized content and the reference content and evaluates a loss function to update weights of the shading neural network 230. The choice of the loss function may be crucial for achieving a visual appearance that matches the original material. Using an L¹-loss function makes the approximation work well in the darker regions of the BSDF, whereas the L²-loss focusses accuracy on the highlights. To maintain visual appearance in all regions of the BSDF, a relative MSE based on the pixel loss function may be used

$$ℒ ( {M}_{θ} , {L}_{r} ) = \frac{{( {M}_{θ} - {L}_{r} )}^{2}}{max \{ {L}_{r}^{2} , ϵ \}}$$

that computes an error that is relative to the magnitude of the function, thus giving uniform importance to all regions. For training stability, the gradient L²-norm may be clamped to a maximum of 1. This helps with training convergence and avoids situations where exploding gradients would derail the optimization process.

After the material shading neural network 230 is trained using the noise-free reference content, in an embodiment, the denoiser neural network 140 is trained using the Noise2Noise method on randomly selected screen tiles. Noise2Noise training trains a denoising model using only noisy images, without ever seeing the clean, ground-truth images. Convergence is guaranteed, because the expected value of multiple noisy versions of an image converges to the clean image. As the range compression from equation (6) is based on a wide blur, large tiles of 512×512 pixels may be used, which also ensures that the boundary handling of the tiles does not dominate the gradients.

FIG. 3B illustrates an example denoiser training configuration 340 suitable for use in implementing some embodiments of the present disclosure. The denoiser training configuration 340 comprises the content synthesis system 100, the path tracer 105, BSDF unit 115, projection unit 110, and an optimization unit 335. The optimization unit 225 receives the synthesized content and the reference content and updates weights of the denoiser neural network 140 based on evaluation of a loss function.

Using real scene geometry and one sample per pixel, the locations x, the normals \hat{n}, and the depth buffer d are rendered. For each pixel, material parameters are sampled uniformly in order to train independently from the actual scene materials. Sharing this data, two independently sampled projected space representations μ_{A} and μ_{B} are generated that obviously exhibit identically distributed noise level statistics across the pixels. A random position is sampled on the light source and visibility is computed using ray tracing. These training examples are shaded using the neural BSDF unit 115, instead of the reference BSDF unit 315. Consequently, differences between the neural BSDF unit 115 and reference BSDF unit 315 do not influence the training process.

The optimization unit 335 implements a primary loss function, comprising a relative MSE loss function such that each training example and each region of a training example is uniformly weighted in the optimization procedure. As in the Noise2Noise scenario, the reference content is not available for normalizing the loss, the loss is normalized by the denoised result. By disabling (detaching) the gradient flow for the denominator of the loss, the loss remains unbiased:

$$ℒ ( {M}_{θ} , {U}_{θ} , {μ}_{A}^{c} , {μ}_{B}^{c} , \hat{n} , \hat{d} , x ) = \frac{{( {M}_{θ} ( {U}_{θ} ( {μ}_{A}^{c} , \hat{n} , \hat{d} ) , x ) − {M}_{θ} ( {μ}_{B}^{c} , x ) )}^{2}}{max \{ 0.5 ⋆ {{M}_{θ} ( {U}_{θ}^{detach} ( {μ}_{A}^{c} , \hat{n} , \hat{d} ) , x )}^{2} + 0.5 ⋆ {M}_{θ} {( {U}_{θ}^{detach} ( {μ}_{B}^{c} , \hat{n} , \hat{d} ) , x )}^{2} , ϵ \}}$$

where ϵ=0.00001. The superscript c is the shorthand for the compressed projected irradiance as in equation (6). Stability of optimization is improved by normalizing by the average of the squares of the denoiser outputs both for the input and the reference. An additional loss or consistency constraint is particularly helpful for low numbers of samples per pixel (spp) in Noise2Noise training.

The concept of the loss function is that for two realizations of samples for the same frame, the denoiser neural network 140 should be producing identical output. The same relative MSE loss as previously described may be used, however the loss now measures the error between the two denoised images.

$$ℒ ( {M}_{θ} , {U}_{θ} , {μ}_{A}^{c} , {μ}_{B}^{c} , \hat{n} , \hat{d} , x ) = \frac{{( {M}_{θ} ( {U}_{θ} ( {μ}_{A}^{c} , \hat{n} , \hat{d} ) , x ) − {M}_{θ} ( {U}_{θ}^{detach} ( {μ}_{B}^{c} , \hat{n} , \hat{d} ) , x ) )}^{2}}{max \{ 0.5 ⋆ {{M}_{θ} ( {U}_{θ}^{detach} ( {μ}_{A}^{c} , \hat{n} , \hat{d} ) , x )}^{2} + 0.5 ⋆ {M}_{θ} {( {U}_{θ}^{detach} ( {μ}_{B}^{c} , \hat{n} , \hat{d} ) , x )}^{2} , ϵ \}}$$

As before, the gradient flow is only enabled for the prediction. Swapping the roles of the μ_{A} used for prediction and μ_{B} used for the reference provide an efficient data augmentation. In an embodiment, the training data is augmented by randomly permuting the RGB channels and randomly zeroing out one color channel in order to prevent the denoiser neural network 140 from mixing colors across channels and yet taking advantage of the shared geometry information.

Alternatively, the denoiser neural network 140 can be trained Noise2Noise independent of the material decoder. The simplified training procedure then just independently samples two projected space representations μ_{A} and μ_{B} that obviously exhibit identically distributed noise level statistics across the pixels. Then, the relative MSE loss function evaluated by the optimization unit 335 amounts to

$$ℒ ( {U}_{θ} , {μ}_{A}^{c} , {μ}_{B}^{c} , \hat{n} , \hat{d} ) = \frac{{( {U}_{θ} ( {μ}_{A}^{c} , \hat{n} , \hat{d} ) - {μ}_{B}^{c} )}^{2}}{max \{ 0.5 ⋆ {{U}_{θ}^{detach} ( {μ}_{A}^{c} , \hat{n} , \hat{d} )}^{2} + 0.5 ⋆ {{U}_{θ}^{detach} ( {μ}_{B}^{c} , \hat{n} , \hat{d} )}^{2} , ϵ \}}$$

and the consistency constraint becomes

$$ℒ ( {U}_{θ} , {μ}_{A}^{c} , {μ}_{B}^{c} , \hat{n} , \hat{d} ) = \frac{{( {U}_{θ} ( {μ}_{A}^{c} , \hat{n} , \hat{d} ) - {U}_{θ}^{detach} ( {μ}_{B}^{c} , \hat{n} , \hat{d} ) )}^{2}}{max \{ 0.5 ⋆ {{U}_{θ}^{detach} ( {μ}_{A}^{c} , \hat{n} , \hat{d} )}^{2} + 0.5 ⋆ {{U}_{θ}^{detach} ( {μ}_{B}^{c} , \hat{n} , \hat{d} )}^{2} , ϵ \}} .$$

Since the shading neural network 230 is trained independently from scene geometry and separately from the denoiser neural network 140, there is an opportunity to explore the feasibility of real time training the material decoder as a cache for complex appearances. Furthermore, the parameters for the shading neural network 230 can be fed by neural textures, and the shading neural network 230 itself can be trained to represent appearance.

After training the shading neural network 230 and denoiser neural network 140, the content synthesis system 100 runs in real-time. Especially in computer graphics, many functions can be visualized and hence understood quickly. This opens up a new way of discovery: Understanding what the neural networks are really approximating. In fact, preliminary experiments explored representing E as a ResNet E_{θ} with 6 ResNet blocks of 16 neurons each. Visualizations after training reveal that one component remains mostly constant, while the remaining components approximate the lobes of a BSDF, very similar to a mixture of spherical Gaussians. As a consequence, modeling E analytically as described herein avoids training an additional neural network, resulting in a more efficient and robust algorithm.

The performance and training success of neural networks strongly depend on the input parameters. Using a neural network E_{θ}, therefore considers all directions (ω, ωᵣ) relative to the view-aligned tangent space. Anchored in the point x, its axes (tₓ, t_{y}, \hat{n}) are defined by tₓ: =ωᵣ×\ddot{n} and t_{y}:=tₓ×\hat{n}, where \hat{n} is the surface normal in x. Using ωᵣ in the construction, the tangent space is aligned with the viewing direction. Due to that alignment, any viewing direction ωᵣ is completely specified by the angle θᵣ between the viewing direction and the surface normal \hat{n}. This parametrization is key to the efficient implementation of the algorithm and furthermore simplifies training.

The geometry is verified to be in general position in order to avoid numerical issues that arise from a zero cross product. Such numerical issues are caused, for example, when x coincides with the viewpoint, or the viewpoint is on the line defined by x and the normal. In summary, the neural network input parameters are: The incident unit direction ω in view-aligned tangent space and the cosine cos θᵣ of the angle between the normal \hat{n} and direction of observation ωᵣ.

FIG. 3C illustrates a flowchart of a method 350 for synthesizing content using parametric integration, in accordance with an embodiment. Each block of method 350, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 350 is described, by way of example, with respect to the content synthesis system 100 of FIG. 1B, the material shading training configuration 300 of FIG. 3A, and the denoiser training configuration 340 of FIG. 3B. However, this method may additionally or alternatively be executed by any one system, or any combination of systems, including, but not limited to, those described herein. Furthermore, persons of ordinary skill in the art will understand that any system that performs method 350 is within the scope and spirit of embodiments of the present disclosure.

At step 355, at least one function (Lᵢ(x, ω)) to be integrated for synthesizing content is projected onto at least one linear vector space spanned by components of a vector of functions (E), producing at least one set of projections (μ). In an embodiment, the linear vector space is a parametric linear vector space. In an embodiment, one component of the vector of functions spanning the linear vector space is constant one. In an embodiment, the projection is evaluated by at least one of Monte Carlo integration, quasi-Monte Carlo integration, and randomized quasi-Monte Carlo integration. In an embodiment, samples of the evaluation of the projection are accumulated in a multiresolution hash grid. In an embodiment, the projection onto the constant one component is used for normalization separately for each component of the at least one function to be integrated.

At step 360, a parametric integral of the at least one function is approximated by a machine learned function (M) using the at least one set of projections, where the machine learned function is trained to approximate the parametric integral. In an embodiment, the machine learned function for approximating the parametric integral is a neural network. In an embodiment, the machine learned function for approximating the parametric integral consumes additional parameters provided by at least one additional function dependent on a parameter of the parametric integral. In an embodiment, the parametric integral represents an image of a 3D scene and the parametric integral solves light transport simulation for the 3D scene. In an embodiment, local exposure is approximated using a filtered version of the image. In an embodiment, the machine learned function to approximate the at least one parametric integral is trained using randomly sampled parameters and without actual scene geometry. In an embodiment, sampling is performed by at least one of rasterization, ray tracing, and a combination of rasterization and ray tracing. In an embodiment, temporal anti-aliasing is applied across a sequence of images including the image in time.

In an embodiment, noise in the evaluation of the projection is filtered across a domain of the parametric integral. In an embodiment, the domain of the parametric integral is subsampled and upscaled for parametric integration. For example, light transport paths may be sampled once in every 2×2 pixel block. The denoiser 120 then fills in the information for the pixels not sampled before shading.

In an embodiment, the noise is filtered by an additional machine learned function. In an embodiment, the additional machine learned function for filtering the noise is a neural network. In an embodiment, the additional machine learned function to filter noise uses at least one of a noise-to-noise loss and a consistency loss. In an embodiment, the machine learned function is trained to approximate the parametric integral and then used to train the additional machine learned function for filtering the noise. In an embodiment, the additional machine learned function for filtering the noise the first machine learned function to approximate the parametric integral are trained independently.

At step 365, the content is synthesized based on the parametric integral. In an embodiment, the content is an image of a 3D scene. In an embodiment, at least one of steps 355, 360, and 365 is performed on a server or in a data center to generate the content and the content is streamed to a user device. In an embodiment, at least one of steps 355, 360, and 365 is performed within a cloud computing environment. In an embodiment, at least one of steps 355, 360, and 365 is performed for training, testing, or certifying a neural network for creating movies, games, or images for display or employed in a headset, machine, robot, or autonomous vehicle. In an embodiment, at least one of steps 355, 360, and 365 is performed on a virtual machine comprising a portion of a graphics processing unit. In an embodiment, at least one of the steps 355, 360, and 365 is implemented to include advanced error correction, fault-tolerance, and self-healing capabilities.

Machine learning in computer graphics comes with the advantage that infinite sequences of unbiased training pairs can be generated efficiently. Starting from the formulation of photorealistic images synthesis as an integro-approximation problem, equation (1) helps to identify which functions need to be learned and which parts are modeled analytically. In an embodiment, a neural radiance cache stores radiance using a multiresolution hash encoding and trains in real-time using temporal accumulation across frames.

The content synthesis system 100 operates on data from only a single frame and overcomes noise masking detail caused by hand-crafted edge stopping heuristics as in conventional techniques. The content synthesis system 100 works with any noise filter in the projected irradiance space and while a U-Net may be trained for that purpose, there is ample opportunity for optimization by replacing at least parts of the denoiser neural network filter by analytic components. The content synthesis system 100 also works with any sampling method and both rasterization and ray tracing.

The content synthesis system 100 is a simple and efficient real-time rendering method that works at extremely low sampling rates. The content synthesis system 100 works on data of only a single frame and does not require temporal information like for example motion vectors. Representing irradiance in a projected space that is spanned by a parametric basis and learning the corresponding integral operator enables efficient denoising in that projected space. The content synthesis system 100 is straightforward to extend to temporal anti-aliasing.

### Parallel Processing Architecture

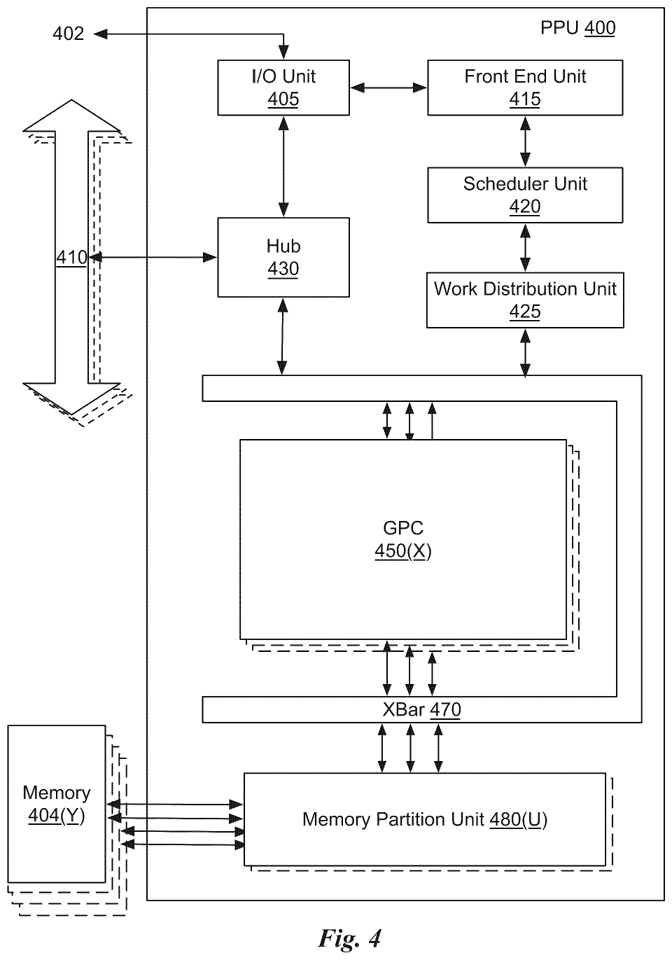

FIG. 4 illustrates a parallel processing unit (PPU) 400, in accordance with an embodiment. The PPU 400 may be used to synthesize content, in accordance with an embodiment. In an embodiment, a processor such as the PPU 400 may be configured to implement the content synthesis system 100 of FIG. 1B, the material shading training configuration 300 of FIG. 3A, and the denoiser training configuration 340 of FIG. 3B. A neural network model may be implemented as software instructions executed by the processor or, in other embodiments, the processor can include a matrix of hardware elements configured to process a set of inputs (e.g., electrical signals representing values) to generate a set of outputs, which can represent activations of the neural network model. In yet other embodiments, the neural network model can be implemented as a combination of software instructions and processing performed by a matrix of hardware elements. Implementing the neural network model can include determining a set of parameters for the neural network model through, e.g., supervised or unsupervised training of the neural network model as well as, or in the alternative, performing inference using the set of parameters to process novel sets of inputs.

In an embodiment, the PPU 400 is a multi-threaded processor that is implemented on one or more integrated circuit devices. The PPU 400 is a latency hiding architecture designed to process many threads in parallel. A thread (e.g., a thread of execution) is an instantiation of a set of instructions configured to be executed by the PPU 400. In an embodiment, the PPU 400 is a graphics processing unit (GPU) configured to implement a graphics rendering pipeline for processing three-dimensional (3D) graphics data in order to generate two-dimensional (2D) image data for display on a display device. In other embodiments, the PPU 400 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more PPUs 400 may be configured to accelerate thousands of High Performance Computing (HPC), data center, cloud computing, and machine learning applications. The PPU 400 may be configured to accelerate numerous deep learning systems and applications for autonomous vehicles, simulation, computational graphics such as ray or path tracing, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 4, the PPU 400 includes an Input/Output (I/O) unit 405, a front end unit 415, a scheduler unit 420, a work distribution unit 425, a hub 430, a crossbar (Xbar) 470, one or more general processing clusters (GPCs) 450, and one or more memory partition units 480. The PPU 400 may be connected to a host processor or other PPUs 400 via one or more high-speed NVLink 410 interconnect. The PPU 400 may be connected to a host processor or other peripheral devices via an interconnect 402. The PPU 400 may also be connected to a local memory 404 comprising a number of memory devices. In an embodiment, the local memory may comprise a number of dynamic random access memory (DRAM) devices. The DRAM devices may be configured as a high-bandwidth memory (HBM) subsystem, with multiple DRAM dies stacked within each device.

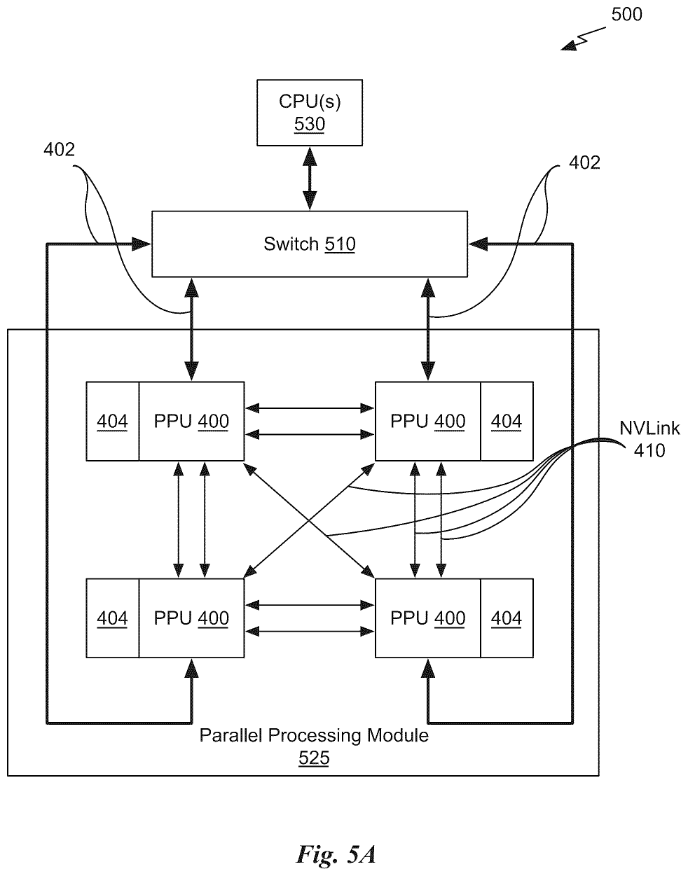

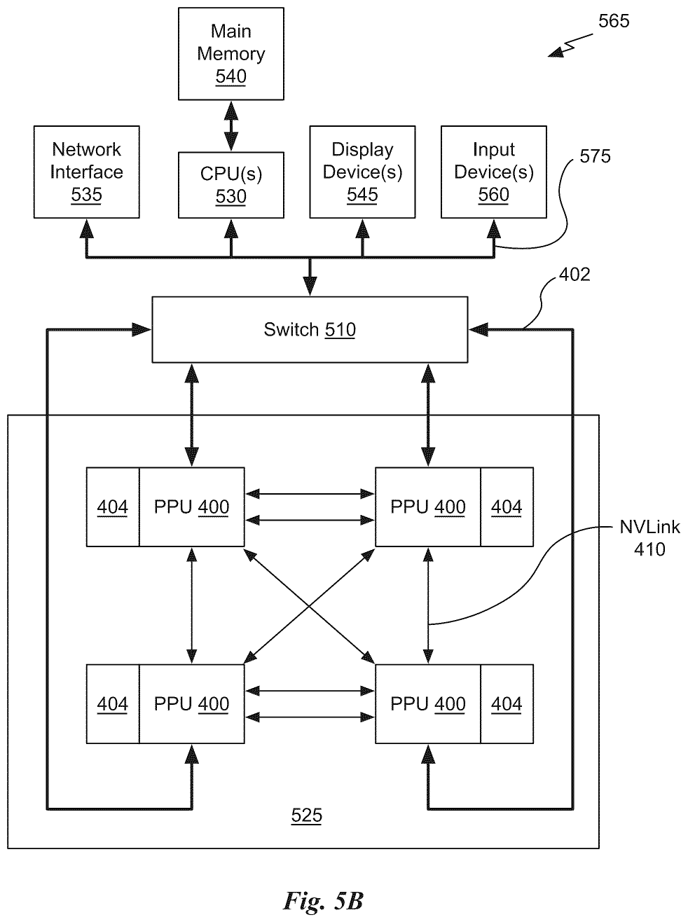

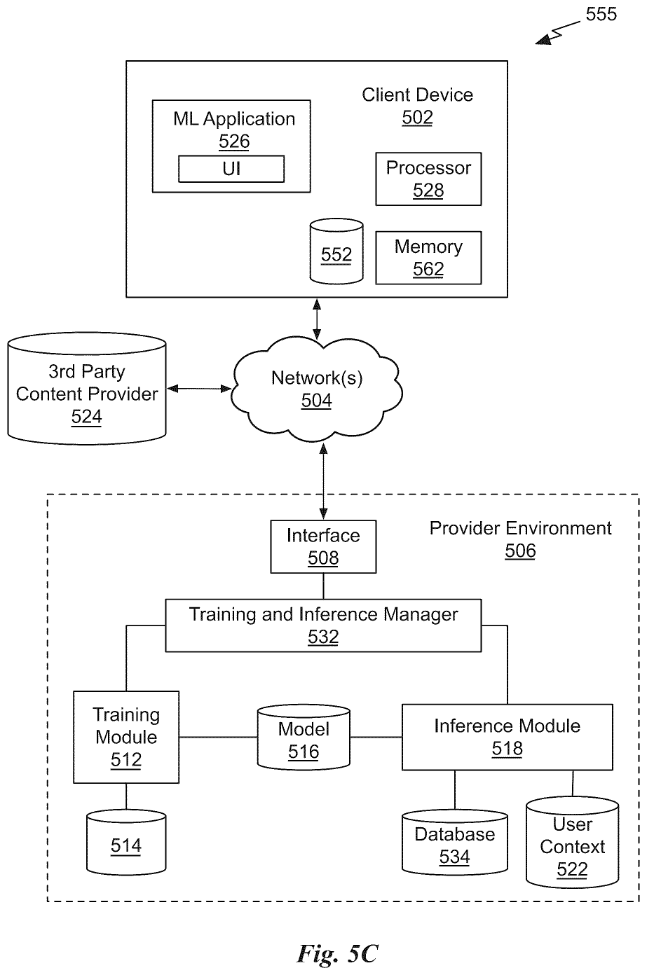

The NVLink 410 interconnect enables systems to scale and include one or more PPUs 400 combined with one or more CPUs, supports cache coherence between the PPUs 400 and CPUs, and CPU mastering. Data and/or commands may be transmitted by the NVLink 410 through the hub 430 to/from other units of the PPU 400 such as one or more copy engines, a video encoder, a video decoder, a power management unit, etc. (not explicitly shown). The NVLink 410 is described in more detail in conjunction with FIG. 5B.

The I/O unit 405 is configured to transmit and receive communications (e.g., commands, data, etc.) from a host processor (not shown) over the interconnect 402. The I/O unit 405 may communicate with the host processor directly via the interconnect 402 or through one or more intermediate devices such as a memory bridge. In an embodiment, the I/O unit 405 may communicate with one or more other processors, such as one or more the PPUs 400 via the interconnect 402. In an embodiment, the I/O unit 405 implements a Peripheral Component Interconnect Express (PCIe) interface for communications over a PCIe bus and the interconnect 402 is a PCIe bus. In alternative embodiments, the I/O unit 405 may implement other types of well-known interfaces for communicating with external devices.

The I/O unit 405 decodes packets received via the interconnect 402. In an embodiment, the packets represent commands configured to cause the PPU 400 to perform various operations. The I/O unit 405 transmits the decoded commands to various other units of the PPU 400 as the commands may specify. For example, some commands may be transmitted to the front end unit 415. Other commands may be transmitted to the hub 430 or other units of the PPU 400 such as one or more copy engines, a video encoder, a video decoder, a power management unit, etc. (not explicitly shown). In other words, the I/O unit 405 is configured to route communications between and among the various logical units of the PPU 400.

In an embodiment, a program executed by the host processor encodes a command stream in a buffer that provides workloads to the PPU 400 for processing. A workload may comprise several instructions and data to be processed by those instructions. The buffer is a region in a memory that is accessible (e.g., read/write) by both the host processor and the PPU 400. For example, the I/O unit 405 may be configured to access the buffer in a system memory connected to the interconnect 402 via memory requests transmitted over the interconnect 402. In an embodiment, the host processor writes the command stream to the buffer and then transmits a pointer to the start of the command stream to the PPU 400. The front end unit 415 receives pointers to one or more command streams. The front end unit 415 manages the one or more streams, reading commands from the streams and forwarding commands to the various units of the PPU 400.

The front end unit 415 is coupled to a scheduler unit 420 that configures the various GPCs 450 to process tasks defined by the one or more streams. The scheduler unit 420 is configured to track state information related to the various tasks managed by the scheduler unit 420. The state may indicate which GPC 450 a task is assigned to, whether the task is active or inactive, a priority level associated with the task, and so forth. The scheduler unit 420 manages the execution of a plurality of tasks on the one or more GPCs 450.

The scheduler unit 420 is coupled to a work distribution unit 425 that is configured to dispatch tasks for execution on the GPCs 450. The work distribution unit 425 may track a number of scheduled tasks received from the scheduler unit 420. In an embodiment, the work distribution unit 425 manages a pending task pool and an active task pool for each of the GPCs 450. As a GPC 450 finishes the execution of a task, that task is evicted from the active task pool for the GPC 450 and one of the other tasks from the pending task pool is selected and scheduled for execution on the GPC 450. If an active task has been idle on the GPC 450, such as while waiting for a data dependency to be resolved, then the active task may be evicted from the GPC 450 and returned to the pending task pool while another task in the pending task pool is selected and scheduled for execution on the GPC 450.

In an embodiment, a host processor executes a driver kernel that implements an application programming interface (API) that enables one or more applications executing on the host processor to schedule operations for execution on the PPU 400. In an embodiment, multiple compute applications are simultaneously executed by the PPU 400 and the PPU 400 provides isolation, quality of service (QOS), and independent address spaces for the multiple compute applications. An application may generate instructions (e.g., API calls) that cause the driver kernel to generate one or more tasks for execution by the PPU 400. The driver kernel outputs tasks to one or more streams being processed by the PPU 400. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. The tasks may be allocated to one or more processing units within a GPC 450 and instructions are scheduled for execution by at least one warp.

The work distribution unit 425 communicates with the one or more GPCs 450 via XBar 470. The XBar 470 is an interconnect network that couples many of the units of the PPU 400 to other units of the PPU 400. For example, the XBar 470 may be configured to couple the work distribution unit 425 to a particular GPC 450. Although not shown explicitly, one or more other units of the PPU 400 may also be connected to the XBar 470 via the hub 430.

The tasks are managed by the scheduler unit 420 and dispatched to a GPC 450 by the work distribution unit 425. The GPC 450 is configured to process the task and generate results. The results may be consumed by other tasks within the GPC 450, routed to a different GPC 450 via the XBar 470, or stored in the memory 404. The results can be written to the memory 404 via the memory partition units 480, which implement a memory interface for reading and writing data to/from the memory 404. The results can be transmitted to another PPU 400 or CPU via the NVLink 410. In an embodiment, the PPU 400 includes a number U of memory partition units 480 that is equal to the number of separate and distinct memory devices of the memory 404 coupled to the PPU 400. Each GPC 450 may include a memory management unit to provide translation of virtual addresses into physical addresses, memory protection, and arbitration of memory requests. In an embodiment, the memory management unit provides one or more translation lookaside buffers (TLBs) for performing translation of virtual addresses into physical addresses in the memory 404.

In an embodiment, the memory partition unit 480 includes a Raster Operations (ROP) unit, a level two (L2) cache, and a memory interface that is coupled to the memory 404. The memory interface may implement 32, 64, 128, 1024-bit data buses, or the like, for high-speed data transfer. The PPU 400 may be connected to up to Y memory devices, such as high bandwidth memory stacks or graphics double-data-rate, version 5, synchronous dynamic random access memory, or other types of persistent storage. In an embodiment, the memory interface implements an HBM2 memory interface and Y equals half U. In an embodiment, the HBM2 memory stacks are located on the same physical package as the PPU 400, providing substantial power and area savings compared with conventional GDDR5 SDRAM systems. In an embodiment, each HBM2 stack includes four memory dies and Y equals 4, with each HBM2 stack including two 128-bit channels per die for a total of 8 channels and a data bus width of 1024 bits.

In an embodiment, the memory 404 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where PPUs 400 process very large datasets and/or run applications for extended periods.

In an embodiment, the PPU 400 implements a multi-level memory hierarchy. In an embodiment, the memory partition unit 480 supports a unified memory to provide a single unified virtual address space for CPU and PPU 400 memory, enabling data sharing between virtual memory systems. In an embodiment the frequency of accesses by a PPU 400 to memory located on other processors is traced to ensure that memory pages are moved to the physical memory of the PPU 400 that is accessing the pages more frequently. In an embodiment, the NVLink 410 supports address translation services allowing the PPU 400 to directly access a CPU's page tables and providing full access to CPU memory by the PPU 400.

In an embodiment, copy engines transfer data between multiple PPUs 400 or between PPUs 400 and CPUs. The copy engines can generate page faults for addresses that are not mapped into the page tables. The memory partition unit 480 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 404 or other system memory may be fetched by the memory partition unit 480 and stored in an L2 cache, which is located on-chip and is shared between the various GPCs 450. As shown, each memory partition unit 480 includes a portion of the L2 cache associated with a corresponding memory 404. Lower level caches may then be implemented in various units within the GPCs 450. For example, each of the processing units within a GPC 450 may implement a level one (L1) cache. The L1 cache is private memory that is dedicated to a particular processing unit. The L2 cache is coupled to the GPCs 450 and the XBar 470 and data from the L2 cache may be fetched and stored in each of the L1 caches for processing.

In an embodiment, the processing units within each GPC 450 implement a SIMD (Single-Instruction, Multiple-Data) architecture where each thread in a group of threads (e.g., a warp) is configured to process a different set of data based on the same set of instructions. All threads in the group of threads execute the same instructions. In another embodiment, the processing unit implements a SIMT (Single-Instruction, Multiple Thread) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads ( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

Each processing unit includes a large number (e.g., 128, etc.) of distinct processing cores (e.g., functional units) that may be fully-pipelined, single-precision, double-precision, and/or mixed precision and include a floating point arithmetic logic unit and an integer arithmetic logic unit. In an embodiment, the floating point arithmetic logic units implement the IEEE 754-2008 standard for floating point arithmetic. In an embodiment, the cores include 64 single-precision (32-bit) floating point cores, 64 integer cores, 32 double-precision (64-bit) floating point cores, and 8 tensor cores.

Tensor cores configured to perform matrix operations. In particular, the tensor cores are configured to perform deep learning matrix arithmetic, such as GEMM (matrix-matrix multiplication) for convolution operations during neural network training and inferencing. In an embodiment, each tensor core operates on a 4×4 matrix and performs a matrix multiply and accumulate operation D=A×B+C, where A, B, C, and D are 4×4 matrices.

In an embodiment, the matrix multiply inputs A and B may be integer, fixed-point, or floating point matrices, while the accumulation matrices C and D may be integer, fixed-point, or floating point matrices of equal or higher bitwidths. In an embodiment, tensor cores operate on one, four, or eight bit integer input data with 32-bit integer accumulation. The 8-bit integer matrix multiply requires 1024 operations and results in a full precision product that is then accumulated using 32-bit integer addition with the other intermediate products for a 8×8×16 matrix multiply. In an embodiment, tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each processing unit may also comprise M special function units (SFUs) that perform special functions (e.g., attribute evaluation, reciprocal square root, and the like). In an embodiment, the SFUs may include a tree traversal unit configured to traverse a hierarchical tree data structure. In an embodiment, the SFUs may include texture unit configured to perform texture map filtering operations. In an embodiment, the texture units are configured to load texture maps (e.g., a 2D array of texels) from the memory 404 and sample the texture maps to produce sampled texture values for use in shader programs executed by the processing unit. In an embodiment, the texture maps are stored in shared memory that may comprise or include an L1 cache. The texture units implement texture operations such as filtering operations using mip-maps (e.g., texture maps of varying levels of detail). In an embodiment, each processing unit includes two texture units.

Each processing unit also comprises N load store units (LSUs) that implement load and store operations between the shared memory and the register file. Each processing unit includes an interconnect network that connects each of the cores to the register file and the LSU to the register file, shared memory. In an embodiment, the interconnect network is a crossbar that can be configured to connect any of the cores to any of the registers in the register file and connect the LSUs to the register file and memory locations in shared memory.

The shared memory is an array of on-chip memory that allows for data storage and communication between the processing units and between threads within a processing unit. In an embodiment, the shared memory comprises 128 KB of storage capacity and is in the path from each of the processing units to the memory partition unit 480. The shared memory can be used to cache reads and writes. One or more of the shared memory, L1 cache, L2 cache, and memory 404 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory enables the shared memory to function as a high-throughput conduit for streaming data while simultaneously providing high-bandwidth and low-latency access to frequently reused data.

When configured for general purpose parallel computation, a simpler configuration can be used compared with graphics processing. Specifically, fixed function graphics processing units, are bypassed, creating a much simpler programming model. In the general purpose parallel computation configuration, the work distribution unit 425 assigns and distributes blocks of threads directly to the processing units within the GPCs 450. Threads execute the same program, using a unique thread ID in the calculation to ensure each thread generates unique results, using the processing unit(s) to execute the program and perform calculations, shared memory to communicate between threads, and the LSU to read and write global memory through the shared memory and the memory partition unit 480. When configured for general purpose parallel computation, the processing units can also write commands that the scheduler unit 420 can use to launch new work on the processing units.

The PPUs 400 may each include, and/or be configured to perform functions of, one or more processing cores and/or components thereof, such as Tensor Cores (TCs), Tensor Processing Units (TPUs), Pixel Visual Cores (PVCs), Ray Tracing (RT) Cores, Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The PPU 400 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the PPU 400 is embodied on a single semiconductor substrate. In another embodiment, the PPU 400 is included in a system-on-a-chip (SoC) along with one or more other devices such as additional PPUs 400, the memory 404, a reduced instruction set computer (RISC) CPU, a memory management unit (MMU), a digital-to-analog converter (DAC), and the like.

In an embodiment, the PPU 400 may be included on a graphics card that includes one or more memory devices. The graphics card may be configured to interface with a PCIe slot on a motherboard of a desktop computer. In yet another embodiment, the PPU 400 may be an integrated graphics processing unit (iGPU) or parallel processor included in the chipset of the motherboard. In yet another embodiment, the PPU 400 may be realized in reconfigurable hardware. In yet another embodiment, parts of the PPU 400 may be realized in reconfigurable hardware.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 5A is a conceptual diagram of a processing system 500 implemented using the PPU 400 of FIG. 4, in accordance with an embodiment. The exemplary system 500 may be configured to enumerate samples of a low discrepancy sequence along a space filling curve and/or to enumerate samples of a rank-1 lattice sequence using injective mapping. The processing system 500 includes a CPU 530, switch 510, and multiple PPUs 400, and respective memories 404.

The NVLink 410 provides high-speed communication links between each of the PPUs 400. Although a particular number of NVLink 410 and interconnect 402 connections are illustrated in FIG. 5B, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 5A, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 5A, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

FIG. 5B illustrates an exemplary system 565 in which the various architecture and/or functionality of the various previous embodiments may be implemented. The exemplary system 565 may be configured to enumerate samples of a low discrepancy sequence along a space filling curve and/or to enumerate samples of a rank-1 lattice sequence using injective mapping. As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5B are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5B is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5B.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may be implemented as a network interface controller (NIC) that includes one or more data processing units (DPUs) to perform operations such as (for example and without limitation) packet parsing and accelerating network processing and communication. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 5A and/or exemplary system 565 of FIG. 5B—e.g., each device may include similar components, features, and/or functionality of the processing system 500 and/or exemplary system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 5A and/or exemplary system 565 of FIG. 5B. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5C illustrates components of an exemplary system 555 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 400 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506.

In at least one embodiment, supervised and/or unsupervised training can be performed by the client device 502 and/or the provider environment 506. In at least one embodiment, a set of training data 514 (e.g., classified or labeled data) is provided as input to function as training data. In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Graphics Processing Pipeline

In an embodiment, the PPU 400 comprises a graphics processing unit (GPU). The PPU 400 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 400 can be configured to process the graphics primitives to generate a frame buffer (e.g., pixel data for each of the pixels of the display).

An application writes model data for a scene (e.g., a collection of vertices and attributes) to a memory such as a system memory or memory 404. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the processing units within the PPU 400 including one or more of a vertex shader, hull shader, domain shader, geometry shader, and a pixel shader. For example, one or more of the processing units may be configured to execute a vertex shader program that processes a number of vertices defined by the model data. In an embodiment, the different processing units may be configured to execute different shader programs concurrently. For example, a first subset of processing units may be configured to execute a vertex shader program while a second subset of processing units may be configured to execute a pixel shader program. The first subset of processing units processes vertex data to produce processed vertex data and writes the processed vertex data to the L2 cache 460 and/or the memory 404. After the processed vertex data is rasterized (e.g., transformed from three-dimensional data into two-dimensional data in screen space) to produce fragment data, the second subset of processing units executes a pixel shader to produce processed fragment data, which is then blended with other processed fragment data and written to the frame buffer in memory 404. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

Images generated applying one or more of the techniques disclosed herein may be displayed on a monitor or other display device. In some embodiments, the display device may be coupled directly to the system or processor generating or rendering the images. In other embodiments, the display device may be coupled indirectly to the system or processor such as via a network. Examples of such networks include the Internet, mobile telecommunications networks, a WIFI network, as well as any other wired and/or wireless networking system. When the display device is indirectly coupled, the images generated by the system or processor may be streamed over the network to the display device. Such streaming allows, for example, video games or other applications, which render images, to be executed on a server, a data center, or in a cloud-based computing environment and the rendered images to be transmitted and displayed on one or more user devices (such as a computer, video game console, smartphone, other mobile device, etc.) that are physically separate from the server or data center. Hence, the techniques disclosed herein can be applied to enhance the images that are streamed and to enhance services that stream images such as NVIDIA Geforce Now (GFN), Google Stadia, and the like.

### Example Streaming System

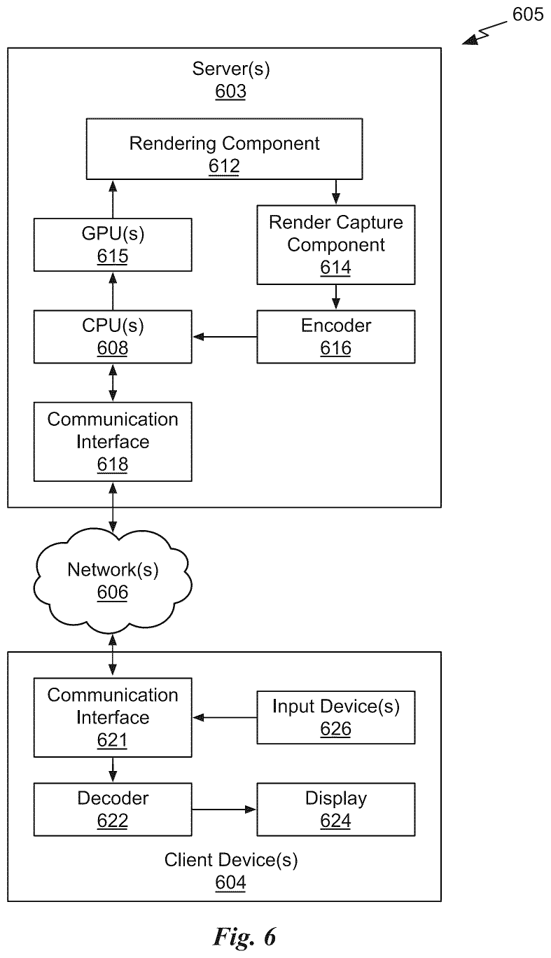

FIG. 6 is an example system diagram for a streaming system 605, in accordance with some embodiments of the present disclosure. FIG. 6 includes server(s) 603 (which may include similar components, features, and/or functionality to the example processing system 500 of FIG. 5A and/or exemplary system 565 of FIG. 5B), client device(s) 604 (which may include similar components, features, and/or functionality to the example processing system 500 of FIG. 5A and/or exemplary system 565 of FIG. 5B), and network(s) 606 (which may be similar to the network(s) described herein). In some embodiments of the present disclosure, the system 605 may be implemented.

In an embodiment, the streaming system 605 is a game streaming system and the server(s) 603 are game server(s). In the system 605, for a game session, the client device(s) 604 may only receive input data in response to inputs to the input device(s) 626, transmit the input data to the server(s) 603, receive encoded display data from the server(s) 603, and display the display data on the display 624. As such, the more computationally intense computing and processing is offloaded to the server(s) 603 (e.g., rendering—in particular ray or path tracing—for graphical output of the game session is executed by the GPU(s) 615 of the server(s) 603). In other words, the game session is streamed to the client device(s) 604 from the server(s) 603, thereby reducing the requirements of the client device(s) 604 for graphics processing and rendering.

For example, with respect to an instantiation of a game session, a client device 604 may be displaying a frame of the game session on the display 624 based on receiving the display data from the server(s) 603. The client device 604 may receive an input to one of the input device(s) 626 and generate input data in response. The client device 604 may transmit the input data to the server(s) 603 via the communication interface 621 and over the network(s) 606 (e.g., the Internet), and the server(s) 603 may receive the input data via the communication interface 618. The CPU(s) 608 may receive the input data, process the input data, and transmit data to the GPU(s) 615 that causes the GPU(s) 615 to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units—such as GPUs, which may further employ the use of one or more dedicated hardware accelerators or processing cores to perform ray or path-tracing techniques—of the server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

It should be understood that the arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. It will be recognized by those skilled in the art that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A computer-implemented method for parametric integration, comprising:
projecting at least one function to be integrated for synthesizing content onto at least one linear vector space spanned by components of a vector of functions, producing at least one set of projections;
approximating a parametric integral of the at least one function by a machine learned function using the at least one set of projections, wherein the machine learned function is trained to approximate the parametric integral; and
synthesizing the content based on the parametric integral.

2. The method of claim 1, wherein one component of the vector of functions spanning the linear vector space is constant one.

3. The method of claim 1, wherein the machine learned function is a neural network.

4. The method of claim 1, wherein the projection is evaluated by at least one of Monte Carlo integration, quasi-Monte Carlo integration, and randomized quasi-Monte Carlo integration.

5. The method of claim 4, wherein samples of the evaluation of the projection are accumulated in a multiresolution hash grid.

6. The method of claim 4, wherein noise in the evaluation of the projection is filtered across a domain of the parametric integral.

7. The method of clean claim 6, wherein the domain of the parametric integral is subsampled and upscaled for parametric integration.

8. The method of claim 6, wherein the noise is filtered by an additional machine learned function.

9. The method of claim 8, wherein the additional machine learned function is neural network.

10. The method of claim 8, wherein the additional machine learned function to filter noise uses at least one of a Noise2Noise loss and a consistency loss.

11. The method of claim 8, wherein the machine learned function is trained to approximate the parametric integral and then used to train the additional machine learned function for filtering the noise.

12. The method of claim 8, wherein the additional machine learned function for filtering the noise and the machine learned function to approximate the parametric integral are trained independently.

13. The method of claim 1, wherein the machine learned function consumes additional parameters provided by at least one additional function dependent on a parameter of the parametric integral.

14. The method of claim 2, wherein the projection onto the constant one component is used for normalization separately for each component of the at least one function to be integrated.

15. The method of claim 1, wherein the parametric integral represents an image of a 3D scene and the parametric integral solves light transport simulation for the 3D scene.

16. The method of claim 15, wherein local exposure is approximated using a filtered version of the image.

17. The method of claim 15, wherein the machine learned function to approximate the at least one parametric integral is trained using randomly sampled parameters and without actual scene geometry.

18. The method of claim 15, wherein sampling is performed by at least one of rasterization, ray tracing, and a combination of rasterization and ray tracing.

19. The method of claim 15, wherein temporal anti-aliasing is applied across a sequence of images including the image in time.

20. The computer-implemented method of claim 1, wherein at least one of the steps of projecting, approximating, and synthesizing is performed on a server or in a data center to generate the content and the content is streamed to a user device.

21. The computer-implemented method of claim 1, wherein at least one of the steps of projecting, approximating, and synthesizing is performed within a cloud computing environment.

22. The computer-implemented method of claim 1, wherein at least one of the steps of projecting, approximating, and synthesizing is performed for training, testing, or certifying a neural network for creating movies, games, or images for display or employed in a headset, machine, robot, or autonomous vehicle.

23. The computer-implemented method of claim 1, wherein at least one of the steps of projecting, approximating, and synthesizing is performed on a virtual machine comprising a portion of a graphics processing unit.

24. The computer-implemented method of claim 1, wherein at least one of the steps of projecting, approximating, and synthesizing is implemented to include advanced error correction, fault-tolerance, and self-healing capabilities.

25. A system for parametric integration, comprising:
a memory that stores content; and
a processor that is connected to the memory and configured to:
project at least one function to be integrated for synthesizing content onto at least one linear vector space spanned by components of a vector of functions, producing at least one set of projections;
approximate a parametric integral of the at least one function by a machine learned function using the at least one set of projections, wherein the machine learned function is trained to approximate the parametric integral; and
synthesize the content based on the parametric integral.

26. The system of claim 25, wherein the projection is evaluated by at least one of Monte Carlo integration, quasi-Monte Carlo integration, and randomized quasi-Monte Carlo integration and noise in the evaluation of the projection is filtered by an additional machine learned function.

27. A non-transitory computer-readable media storing computer instructions that, when executed by one or more processors, cause the one or more processors to perform the steps of:
projecting at least one function to be integrated for synthesizing content onto at least one linear vector space spanned by components of a vector of functions, producing at least one set of projections;
approximating a parametric integral of the at least one function by a machine learned function using the at least one set of projections, wherein the machine learned function is trained to approximate the parametric integral; and
synthesizing the content based on the parametric integral.

28. The non-transitory computer-readable media of claim 27, wherein the projection is evaluated by at least one of Monte Carlo integration, quasi-Monte Carlo integration, and randomized quasi-Monte Carlo integration and noise in the evaluation of the projection is filtered by an additional machine learned function.

29. A computer-implemented method for synthesizing content, comprising:
receiving incident radiance produced by evaluating light transport paths traced in a three-dimensional (3D) scene;
projecting the incident radiance onto a vector-valued function to compute projected irradiance in a higher dimensional space;
denoising the projected irradiance in the high dimensional space to produce denoised irradiance; and
computing a color for each pixel of the synthesized content using the denoised irradiance and material parameters for the 3D scene.

30. The computer-implemented method of claim 29, wherein the parametric integral represents an image of a 3D scene and the parametric integral solves light transport simulation for the 3D scene.
